(19) United States
(12) Patent Application Publication
(10) Pub. No.: US 2016/0119401 A1
(43) Pub. Date: Apr. 28, 2016

(54) TURNSTILE APPARATUS HOSTING A WEBSITE

(71) Applicant: INTEGRATED DESIGN LIMITED, Fetham, Middlesex (GB)

(72) Inventor: Derek Huff, Feltham, Middlesex (GB)

(21) Appl. No.: 14/889,645

(22) PCT Filed: May 8, 2014
(86) PCT No.: PCT/GB2014/051397

§ 371 Date: Nov. 6, 2015

(30) Foreign Application Priority Data
May 8, 2013 (GB) 1308279.7
Apr. 17, 2014 (GB) 1406964.5

(51) Int. Cl. H04L 29/08; E06B 11/08; H04L 12/24

(52) U.S. Cl. CPC H04L 67/02; H04L 41/0803; H04L 41/20; E06B 11/08

(57) ABSTRACT

Turnstile apparatus hosting a website which is accessible to provide control, configuration and/or monitoring of one or more lanes of turnstile.

Turnstiles provide a key function within the entrance of a building. These products are integrated with Access Control products for providing authorisation for ingress and egress in addition to alarm event management. In addition, local control and monitoring of the turnstiles are typically required.

Nowadays, turnstiles are often so-called ‘optical turnstiles’ or ‘speedgates’ in which an array of light emitters/receivers is used to monitor passage, either in conjunction with a mechanical barrier or without one. The term ‘turnstile’ herein encompasses any of these.

The turnstiles are generally required to operate 24 hrs a day 365 days a year. A fault or impaired performance can be a significant problem to the operation of the buildings entrance control system.

It is generally required to have a local operator in the vicinity of the turnstile who can monitor the turnstile's use and respond to any anomalies which may arise, or can control the turnstile.

The invention arose in an attempt to provide an access control apparatus such as a turnstile which can be monitored and/or controlled more remotely if necessary.

According to the present invention in a first aspect there is provided a turnstile apparatus hosting a website which is accessible to provide control, configuration and/or monitoring of one or more lanes of the turnstile.

This invention facilitates greater integration to access control products and a faster response using on-line support to locations that require a significant period of time for travel, which in some cases may be avoided by on-line diagnostics for local repair.

Embodiments of the invention enable suitably qualified service engineers to be able to connect to and control the turnstile remotely at any global location that has internet access for the purpose of providing or supporting fault diagnostics and firmware upgrades.

The engineer or other operators or persons monitoring or controlling the system may use any type of computer equipment, PCs, laptops, mobile devices and so which can view and/or interact with websites. Typically, a graphical user interface is provided on a display of the remote device which is connected to the turnstile apparatus.

The website may be hosted within a pedestal which includes the hardware and software that controls each turnstile lane and provides local control, configuration and monitoring of the turnstile lanes. Remote connection to this website provides an on-line means for monitoring the performance and functionality of the turnstile.

Most preferably, TCP/IP technology, as is well known in itself, may be used, to improve the integration of the access control system/turnstile system. Common Gateway Instructions (CGI) may be used to communicate with the lane.

Considerable benefits arise from remote control for service and support, such as being able to effectively monitor and control the barrier 24 hours a day, 365 days a year and the ability for an organisation to monitor a large number of such turnstiles. A large amount of diagnostic, or fault finding information may also be able to be provided and this may be provided directly for engineering staff who can therefore much more effectively and efficiently respond.

By using TCP/IP technology and a website, any person with a suitable web browser may access the system. Of course, generally passwords and/or other security methods will be use to ensure that only authorised persons can do this.

The invention further provides a method of controlling, monitoring and/or configuring turnstile apparatus, comprising a website at the turnstile apparatus and using this to provide control, configuration and/or monitoring of the website remotely.

In a further aspect, there is provided turnstile apparatus comprising a web server.

Embodiments of the invention will now be described by way of reference only with reference to, and as illustrated by, the accompanying drawings, in which:

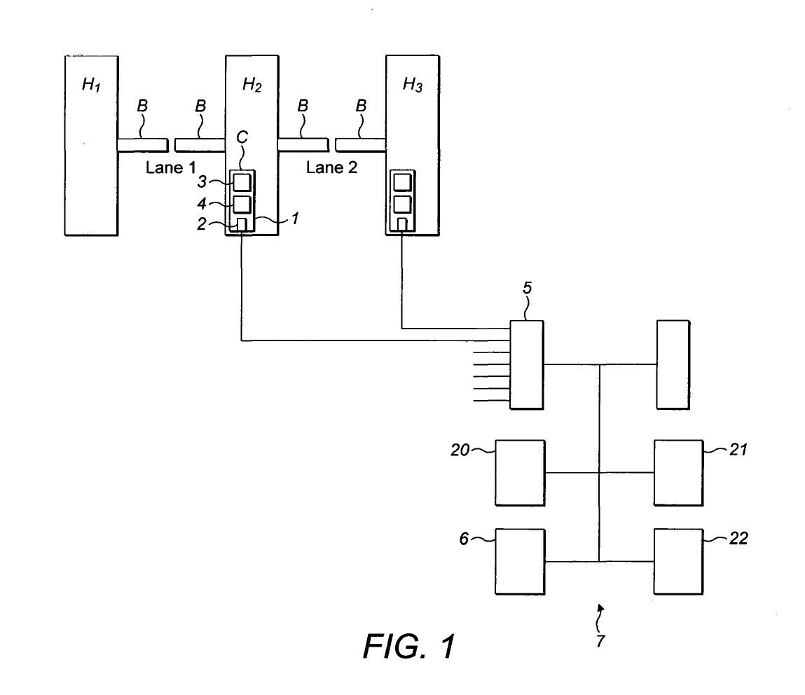

FIG. 1 shows a control system for a two lane turnstile apparatus;

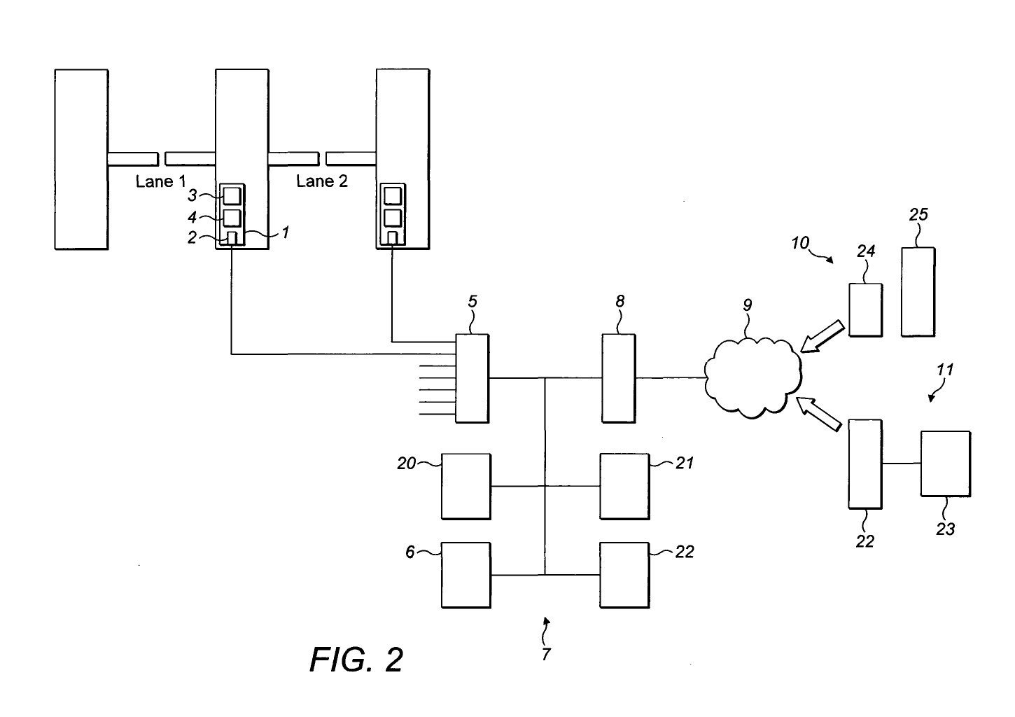

FIGS. 2 shows an alternative control system for a two lane turnstile apparatus; and

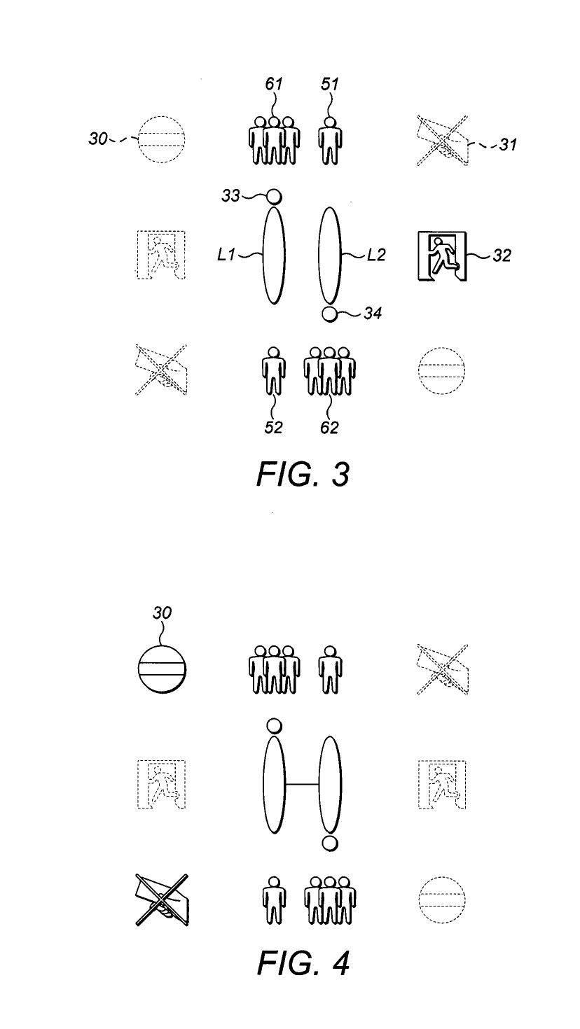

FIGS. 3 to 5 show, schematically, examples of parts of the display that a user may view on a device screen and be able to interact with.

Referring to FIG. 1, an access control system is shown which has optical turnstile apparatus utilising two lanes, Lane One and Lane One. These lanes may be formed by three pedestal H1, H2 and H3 comprising housings, IR or other transmission and/or sensing apparatus and control hardware/software. Thus a pair of pedestals may delimit and define a ‘lane’. In this specification, a lane includes the two pedestals. The control apparatus for lane one is in pedestal H2 and the control apparatus for lane two is in pedestal H3. Each lane includes a pair of barriers B which can operate to allow passage of a person in the normal manner. To control the respective lanes, a control unit C is provided within H2, H3. The control unit C comprises a processor 1 and turnstile firmware 3 and providing a hosted website 4. Thus, it acts as a web server and the site is hosted at the apparatus itself. An input/output port such as an Ethernet port 2 is also provided. This can be used for programming, input/output functions and so on. Thus, the system includes firmware for the turnstile function as well as software for hosting the website 4 for the respective turnstile lane.

The Ethernet port 2 of each respective turnstile lane; Lane One and Lane Two, is connected to an Ethernet hub 5 which is then connected to a local area network. As shown, this comprises, in one embodiment, a workstation 20, file servers 21, a reception PC 6 (located in a reception area which may be in the vicinity of the lanes but need not be) and various network devices 22. Each website may have its own unique IP address and therefore this can be addressed using this IP address using, for example, the reception PC 6 connected to the local area network (LAN) 7. The website 4 resident at each turnstile provides a means to configure, monitor and control the respective lane. Thus, a user at the reception PC can monitor users, allow people in or out, view diagnostic information and so on. The hosted website may obtain and/or store diverse data and this may be birth to death data relating to the turnstile but may alternatively, or in addition, include resettable counters for each day, each week and may include data representative of the numbers of people passing in each way, diagnostic/fault information, attempts to force entry which has been refused and so on. Note that each lane may include means for a person to present authorisation, such as an smartcard, to enter a code or otherwise so that it only allows people with authorisation to pass, or it may be controlled from the reception desk, for example. Many other alternatives are possible.

FIG. 2 shows an alternative control system, the lanes provides the same functionality as before including the processor, hosted website, etc and the local area network and Ethernet port is also shown. This embodiment also includes a router 8 which provides a connection of the local area network 7 to the Internet 9. Thus, devices anywhere in the world having an Internet connection may be able to connect to, view and interact with, the respective websites on Lane One and Lane Two. The figure shows a router 22 at a remote location and a computer 23 attached to this router having a suitable web browser. Mobile devices may also be connected over the Internet, or by local WiFi, such as smart phones 24, tablets 25 and so on.

In some embodiments, the invention may use common gateway interface (CGI) commands and an XML data table to enable integration to access control products using the Ethernet port 2. Presently, it is believed that relay outputs and logic inputs are used to provide authorised entry/exit signals and alarms.

By using common standards (such as TCP/IP, CGI, XML for example) integration with the access control system (ie the lanes and their controllers) are not limited by hardware since the vast majority of connectable devices will be able to connect to the websites and therefore be used for control, monitoring and so on of the lanes. Any additional functions and data may be provided, such as entry and exit counts, various alarm systems and systems status.

FIGS. 3 to 5 show schematically parts of a display in one embodiment. FIG. 3 shows a graphical representation of a single lane showing each pedestal L1 and L2, images of a group of people G1 and G2 associated with each lane and of a single person S1 and S2. It also shows various icons, such as NO ENTRY sign 30, an icon indicating a hand with a smartcard 31, a passageway sign 32 and so on. These will be duplicated such that icons are shown for both entry and exit.

In one embodiment, a user may simply click upon one or more of these icons to activate the functionality. Thus, by clicking on an icon 30 (no access) the entry direction is closed, and by clicking again that lane may be opened. By clicking on a ‘single person’ image such as S1 or S2 (single person access) then only a single person will be allowed at any time in the respective direction (entry or exit) and if the system detects that more than one person is trying to enter it will assert an alarm (red flashing icons 33 and 34). By clicking on the icon G1 or G2 (group access), then a number of people may be allowed through the lane in the respective direction.

By clicking the icon 31 (Card not Required) the lane will enter a “card not required” mode of operation for that direction, and persons detected by the optical system will open the lane in that respective direction. The icons are normally greyed out, as shown by icons 30 and 31, if not actuated or may be illuminated when actuated such as shown by icon 32. The dots 33, 34 provide lane status, white for standby, green for a single user authorisation, flashing green for a group authorisation, red for lane closed and flashing red for an alarm.

FIG. 4 shows an example in which Icon 30 (No Access) has been actuated for the entry direction, Icon 30 will be illuminated. The icon 33 will be red and the lane will not accept entry authorisations thereby closing the lane in this direction. FIG. 4 also shows Icon 38 (Card not Required) activated, which puts the lane in a free exit mode.

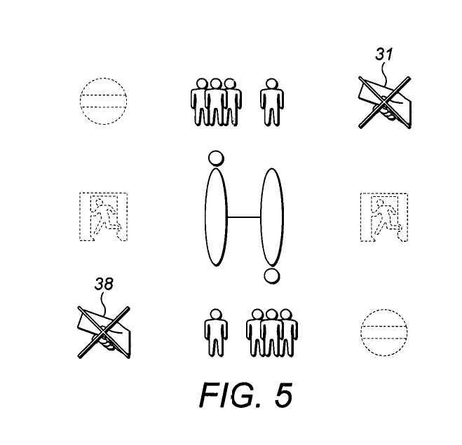

FIG. 5 shows another example of Card Not Required, in this example both entry and exit icons are illuminated 31, 38 indicating that both entry and exit directions are operating in free entry and exit mode.

This control scheme is just by way of example only and many other options may be possible.

Administration screens may be provided, to configure the TCP/IP Port as required, and to set security passwords. These pages may provide particular lane names or identification, its software version and so on and of course a user may be required to log in to view the system or to control and/or monitor respective lanes.

The system may be used in real-time for a user to observe use of one or more lanes.

Engineer's pages may be provided providing suitable diagnostic information including, for example, numbers of power ups, numbers of cycles, number of times forced, numbers of users who have traversed and so on in each direction.

Alarms may be provided as well to indicate many events, such as when a fault has occurred, when a person has forced the system, tamper alarms, optical obstructions, unauthorised access or other detected alarmed situations eg using TCP/IP communications.

Note that although only a single lane may be represented by a particular web page, multiple pages may be opened for various lanes to enable control of multiple lanes.

The remote device may operate as an access control system. This may be a third party access control system. By using TCP/IP communications and/or Common Gateway Instructions (CGI) commands, this may be used to control, or monitor a lane via the hosted website. The GUI may be provided via this system.

Statistical data may be provided at the remote device (or its access control system). The statistical data may comprise, for example, entry counts, exit counts, power status, manufacturing details or fault diagnostics, eg using TCP/IP communication diagnostic data may be communicated.

Remote firmware/software upgrades may be provided from an authorised remote device with agreement/authorisation to access the lane using a TCP/IP connection.

The system may be integrated with a Heating Ventilation and Air Conditioning (HVAC) systems, or a Building Management System (BMS).

Staff rosters may be controlled or monitored. Maintenance schedules may also be monitored, or a variable maintenance programme based on actual use be implemented, since statistics of use will be readily available.

1. A turnstile system comprising:
a turnstile apparatus comprising a turnstile lane and a control unit; and
hosting a website, hosted by the control unit, which is accessible to provide control, configuration and/or monitoring of one or more lanes of the turnstile.

2. The system of claim 1, wherein the website is accessible outside the apparatus.

3. The system of claim 1, wherein the website is accessible from outside the apparatus using a device having a browser.

4. The system of claim 1, wherein the turnstile lane comprises a pedestal in which the control unit is disposed, the website being hosted within the pedestal.

5. The system of claim 1, further including processing means within the lane for hosting the website within the lane itself and means for communicating from the pedestal with an external hub, router or other apparatus.

6. The system of claim 1, further including an Ethernet port.

7. The system of claim 1, further providing integration through an external access control system.

8. The system of claim 1, wherein the system is configured to provide, at a remote device, one or more alarms.

9. The system of claim 1, wherein the system is configured to provide, at a remote device, statistical data.

10. The system of claim 1, including means for receiving software and/or firmware upgrades from a remote device.

11. The system of claim 1, integrated with a heating ventilation and air conditioning (HVAC) system or a building management system (BMS).

12. A method of controlling, monitoring and/or configuring a turnstile apparatus, comprising a website at the turnstile apparatus and using this to provide control, configuration and/or monitoring of the website remotely.

13. A method as claimed in claim 12, comprising providing an Ethernet port on the turnstile apparatus for communicating with, and interacting with, the hosted website.

14-15. (canceled)

16. A method comprising:
providing a turnstile apparatus comprising a turnstile lane and a control unit; and
controlling the turnstile apparatus using a website hosted by the control unit, which is accessible to provide control, configuration and/or monitoring of one or more lanes of the turnstile.

17. The system of claim 7, wherein integration is provided using TCP/IP communications and/or common gateway instruction.

18. The system of claim 4, wherein the turnstile lane comprises a pair of opposed pedestals.

19. The system of claim 1, further comprising one or more additional turnstile lanes.

20. The method of claim 16, wherein the website is accessible outside the apparatus.

21. The method of claim 16 wherein the website is accessible from outside the apparatus using a device having a browser.

22. The method of claim 16, wherein the turnstile apparatus further comprises a pedestal in which the control unit is disposed, the website being hosted within the pedestal.
